(19) United States
(12) Patent Application Publication
(10) Pub. No.: US 2003/0168784 A1
(43) Pub. Date: Sep. 11, 2003

(54) Method of fabricating a ceramic stack structure

(76) Inventors: Akio Iwase, Nishio-city (JP); Takeshi Matsui, Toyohashi-city (JP)

Correspondence Address: NIXON & VANDERHYE, PC, 1100 N GLEBE ROAD, 8TH FLOOR, ARLINGTON, VA, 22201-4714, US

(21) Appl. No.: 10/376,299

(22) Filed: Mar. 3, 2003

(30) Foreign Application Priority Data
Mar. 6, 2002 (JP) 2002-060768(PAT.

(51) Int. Cl. C04B 33/32

(52) U.S. Cl. 264/605

(57) ABSTRACT

A method of fabricating a ceramic stack structure having dielectric layers which are not easily cracked or delaminated is disclosed. In fabricating a ceramic stack structure having a plurality of dielectric layers and a plurality of internal electrode layers stacked alternately with each other, a carrier film (20) is prepared and a plurality of internal electrode print portions (21) are formed. A large print portion (225) is formed in such a manner as to cover the internal electrode print portions (21). The large print portion (225) is dried and a coat layer (23) is formed in such a manner as to smooth out the unevenness of the surface of the large print portion (225). The large print portion (225) is removed from the carrier film (20) and punched to produce an unsintered unit. The unsintered unit is punched while at the same time stacking and attaching the particular unsintered unit on another unsintered unit under pressure. This process is repeated to produce an unsintered stack body including a plurality of the unsintered units. The unsintered stack body is sintered into a ceramic stack structure.

### BACKGROUND OF THE INVENTION

1. Field of the Invention

The present invention relates to a method of fabricating a ceramic stack structure usable as a piezoelectric device or a ceramic capacitor.

2. Description of the Related Art

A method of fabricating a ceramic stack structure configured of a plurality of dielectric layers and a plurality of internal electrode layers stacked alternately with each other is described below.

As shown in FIGS. 7a to 7d, a plurality of internal electrode layer print portions 21 are formed by being printed on a carrier film 20 in the step of FIG. 7a, the internal electrode layer print portions 21 are dried in the step of FIG. 7b, and a large print portion 225 for a dielectric layer is formed over the dried internal electrode layer print portions 21 in the step of FIG. 7c.

As shown in FIG. 7d, after drying the large print portion 255, the carrier film 20 is removed to produce an unsintered unit including the internal electrode layer print portions and the dielectric layer print portion to the size required for one ceramic stack structure. A plurality of unsintered units are stacked to form an unsintered stack body 9 configured of a stack of alternate layers of a plurality of internal electrode layer print portions 21 and a plurality of dielectric layer print portions 22. This unsintered stack body 9 is sintered thereby to produce a ceramic stack structure (Japanese Unexamined Patent Publications Nos. 56-169315, 64-65832 and 2-288276).

The large print portion 225 for the dielectric layer, which has a smooth surface immediately after being printed, develops depressions 220 about several μm deep, due to contraction by drying, as shown in FIG. 7d.

A plurality of the dielectric layer print portions 22 having a depressed surface undesirably make an unsintered stack body 9 having gaps 91 between adjacent dielectric layer print portions 22, as shown in FIG. 8.

In the case where the number of stacked dielectric layer print portions 22 or the thickness of each dielectric layer print portion 22 is small, the gaps 91 may be filled up and entirely closed under the pressure exerted when the dielectric layer print portions 22 are stacked and pressed against each other into the unsintered stack body 9.

A piezoelectric device composed of a ceramic stack structure has recently found application as a piezoelectric actuator for a fuel injection system of an automotive engine. The piezoelectric device for this application is required to have a high output and a high reliability. A method frequently employed to secure a high output is to decrease the thickness of the dielectric layer and to stack as many as several hundred layers.

In the case where a piezoelectric device is produced using the conventional method of fabricating a ceramic stack structure, the fact that the number of the dielectric layer print portions 22 is very great makes it difficult to close up all the gaps 91 of the unsintered stack body 9.

Once the unsintered stack body 9 is sintered in the presence of the gaps 91, the resulting product may be nothing other than a ceramic stack structure 95 having defects 950 such as cracks or gaps here and there, as shown in FIG. 9.

Further, the ceramic stack structure 95 may be inconveniently delaminated.

The present invention has been achieved in view of the problems of the prior art described above, and the object thereof is to provide a method of fabricating a ceramic stack structure which is not easily cracked or delaminated between dielectric layers.

### SUMMARY OF THE INVENTION

According to a first aspect of the invention, there is provided a method of fabricating a ceramic stack structure configured of a plurality of dielectric layers and a plurality of internal electrode layers stacked alternately with each other, the method comprising the steps of:

preparing a plurality of carrier films;

forming an internal electrode layer print portion on each of the carrier films;

forming a dielectric layer print portion in such a manner as to cover each of the internal electrode layer print portions;

drying each of the dielectric layer print portions;

forming a coat layer in such a manner as to smooth out the unevenness of the surface of each of the dielectric layer print portions thereby to produce an unsintered unit including the internal electrode layer print portion, the dielectric layer print portion and the coat layer;

removing the unsintered unit from the carrier film;

stacking a plurality of the unsintered units into an unsintered stack body; and

sintering the unsintered stack body into a ceramic stack structure.

Next, the operation and the effect of the invention will be explained.

In the fabrication method according to the invention, the process of drying the dielectric layer print portions generates at least a surface depression due to the contraction during the drying process. The coat layer is formed in such a way as to smooth out the depression.

As a result, an unsintered stack body free of gaps is configured of a stack of the dielectric layer print portions covered by a coat layer having a flat surface. After sintering, therefore, a superior ceramic stack structure which is not easily cracked or delaminated can be produced.

According to a second aspect of the invention, there is provided a method of fabricating a ceramic stack structure configured of a plurality of dielectric layers and a plurality of internal electrode layers stacked alternately with each other, the method comprising the steps of:

preparing a plurality of carrier films;

forming a plurality of internal electrode layer print portions on each of the carrier films;

forming a large print portion in such a manner as to cover a plurality of the internal electrode layer print portions;

drying the large print portion;

forming a coat layer in such a manner as to smooth out the unevenness of the surface of the large print portion;

removing the large print portion with the internal electrode layer print portions and the coat layer from each of the carrier films;

punching each of the large print portions thereby to produce an unsintered unit including the internal electrode layer print portion, the dielectric print portion and the coat layer;

punching the unsintered unit while at the same time laying the punched unsintered unit on another unsintered unit under pressure, this step being repeated thereby to form an unsintered stack body; and

sintering the unsintered stack body into a ceramic stack structure (FIG. 6).

While punching and stacking a plurality of unsintered units by the fabrication method according to the second aspect of the invention, the small unevenness such as depressions remaining on the coat layer are smoothed out and corrected. As the coat layer can be bonded with the surface thereof in a very flat state in this way, the gaps or the like formed in the unsintered stack body can be further reduced.

Also, the unsintered stack body free of gaps develops a very small internal stress at the time of sintering, and therefore is even more difficult to delaminate.

Further, in view of the fact that the punching step can be carried out simultaneously with the stacking step, the required fabrication time is shorter than in the case where the punching and stacking steps are carried out separately from each other. Also, no pressure-fitting step of the unsintered units is required, thereby contributing to an improved efficiency of the fabrication process.

The unsintered units can be punched and stacked under pressure either before or after drying the coat layers or the dielectric layer print portions.

Any way, the internal stress of the unsintered stack body can be reduced so greatly that delamination becomes more difficult at the time of sintering.

As described above, the method of fabricating a ceramic stack structure according to the second aspect of the invention has the additional operation and effects other than those of the first aspect of the invention.

It will thus be understood that, according to the first and second aspects of the invention, there is provided a method of fabricating a ceramic stack structure not easily cracked nor easily delaminated between dielectric layers.

### BRIEF DESCRIPTION OF THE DRAWINGS

FIG. 1 is a sectional view for explaining a ceramic stack structure according to an embodiment of the invention.

FIGS. 2a to 2f are diagrams for explaining the steps of fabricating an unsintered stack body according to an embodiment of the invention.

FIG. 3 is a sectional view for explaining a unsintered ceramic stack body according to an embodiment of the invention.

FIG. 4 is a diagram for explaining that an internal electrode layer print portion is formed using a print mask and a large print portion is formed using a coater on a carrier film.

FIG. 5 is a diagram for explaining that an internal electrode layer print portion is formed using a jet nozzle and a large print portion is formed using a coater on a carrier film.

FIG. 6 is a diagram for explaining that the punching step is carried out at the same time as the stacking step according to an embodiment of the invention.

FIGS. 7a to 7d are diagrams for explaining the conventional process of fabricating an unsintered stack body.

FIG. 8 is a sectional view for explaining the conventional unsintered stack body.

FIG. 9 is a diagram for explaining the conventional ceramic stack structure having defects.

### DESCRIPTION OF THE PREFERRED EMBODIMENTS

In the first and second aspects of the invention described above, the ceramic stack structure is used as a piezoelectric device. In this case, a material having the piezoelectric effect can be used as a dielectric layer. Also, the coat layer, which makes up a part of the dielectric layer after sintering, is preferably composed of the same material as the dielectric layer print portion. Even in the case where the coat layer and the dielectric layer are composed of the same material, a boundary between them can be observed after sintering.

In order to improve the production efficiency in the first aspect of the invention, it is also possible to provide a large carrier film with a multiplicity of internal electrode layer print portions, each having a dielectric layer print portion and a coat layer, after which these portions are processed into an unsintered unit of the appropriate size thereby to form an unsintered stack body.

Now, embodiments of the invention will be explained with reference to the accompanying drawings.

(Embodiments)

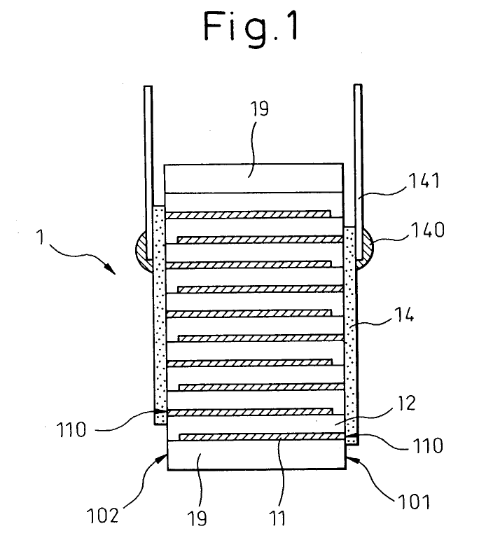

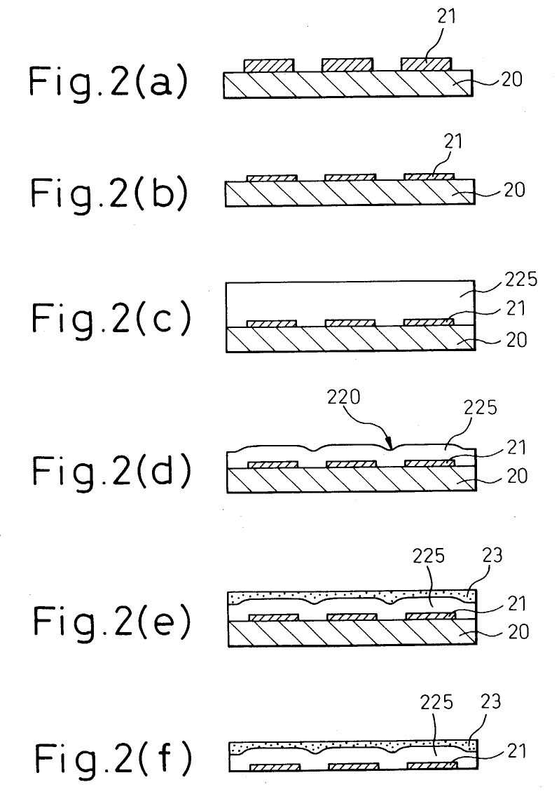

In the embodiment shown in FIG. 1, a ceramic stack structure 1 is fabricated of a plurality of dielectric layers 12 and internal electrode layers 11 stacked alternately with each other. First, as shown in FIGS. 2a to 2f, a carrier film 20 is prepared, and a plurality of internal electrode print portions 21 are formed on the carrier film 20. Then, a large print portion 225 is formed in such a manner as to cover the internal electrode layer print portions 21. After drying the large print portion 225, a coat layer 23 is formed in such a manner as to smooth out the unevenness of the surface of the large print portion 225. After that, the large print portion 225 is removed from the carrier film 20 and punched to produce an unsintered unit 200. The unsintered unit 200, while being punched, is stacked and fitted on another unsintered unit 2 under pressure. This process is repeated to produce an unsintered stack body 2. This unsintered stack body 2 is sintered to produce a ceramic stack structure 1.

The ceramic stack structure 1 according to this embodiment will be explained in detail below.

The ceramic stack structure 1 according to this embodiment makes up a stack-type piezoelectric device for the piezoelectric actuator used with the fuel injection system of the automotive engine.

As shown in FIG. 1, the ceramic stack structure 1 according to this embodiment comprises a plurality of dielectric layers 12 composed of lead zirconate titanate (PZT) constituting a piezoelectric material and a plurality of internal electrode layers 11 of a silver-palladium alloy stacked alternately with each other. The surface of the dielectric layer 12, i.e. the portion of the dielectric layer 12 in contact with an adjacent internal electrode layer 11 makes up a coat layer, which is not shown in FIG. 1. In the ceramic stack structure 1 making up a piezoelectric device, the coat layer functions as a part of the dielectric layer 12.

The end surface 110 of the internal electrode layer 11 is exposed to the side surface 101 or 102 of the ceramic stack structure 1 for every other dielectric layer 12. Side electrodes 14 are formed to secure electrical conduction between the end surfaces 110 of the internal electrode layers 11. Further, a lead portion 141 is connected to each side electrode 14 by means of a conductive paste 140. These lead portions 141 are connected to an external power supply not shown, from which the internal electrode layers 11 are energized.

The thickness of the dielectric layer 12 is 100 μm, and that of the internal electrode layer 11 is 5 μm. To facilitate the understanding of each drawing, the stack includes a smaller number of the dielectric layers 12 and the internal electrode layers 11 than in actual cases. The ceramic stack structure 1 according to this embodiment, however, is actually configured of as many as 500 dielectric layers in stack.

The uppermost and lowest layers of the ceramic stack structure 1 are dummy layers adapted not to expand or contract upon energization thereof, but have the same composition as the dielectric layers 12. Nevertheless, these layers have the internal electrode layer 11 only on one side (or have no internal electrode layer 11), and therefore no voltage is applicable thereto.

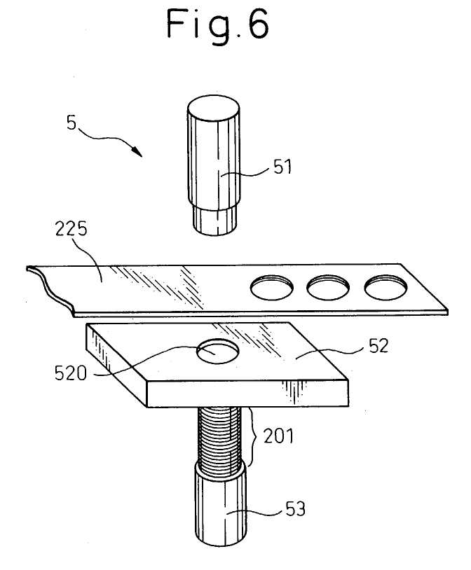

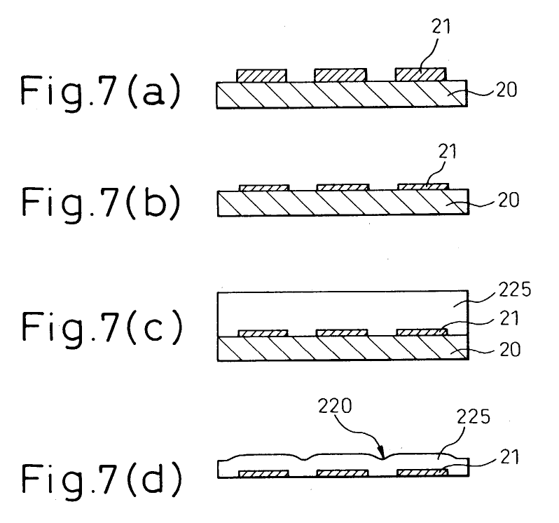

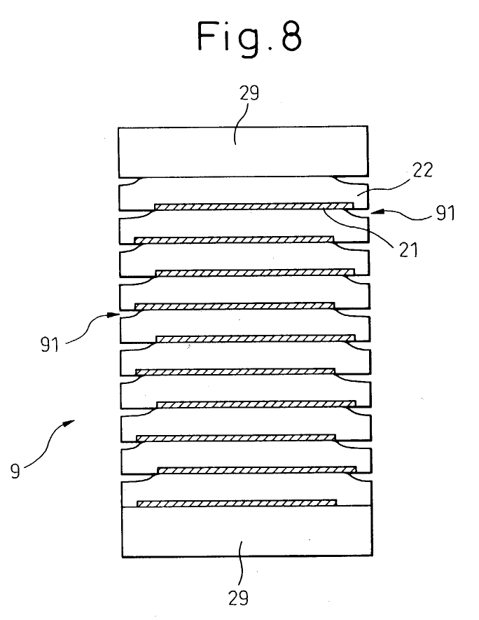

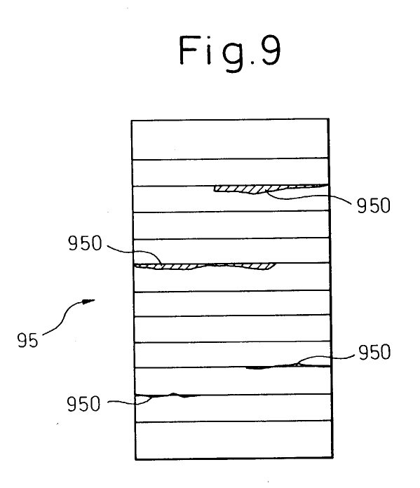

In the ceramic stack structure 1 according to this embodiment, the dielectric layer 12 has a circular cross section (FIG. 6). However, the sectional shape of the ceramic stack structure 1, of course, is not limited to a circle but is modifiable in accordance with applications and the conditions for use.

Next, a method of fabricating the ceramic stack structure 1 according to this embodiment will be explained in detail.

One thousand grams of a material for the dielectric layers and the coat layers of PZT having an average grain size of 0.5 μm is prepared. Forty grams of a binder of PVB (polyvinyl butyral) is added to the material to produce a slurry for the dielectric and coat layers.

An electrode material 60 is prepared which contains 70 wt % silver and 30 wt % palladium with a 40 wt % common material added thereto. The common material is PZT used for preparing the slurry for the dielectric and coat layers. This material is prepared in paste form, using the binder, to obtain the slurry for the internal electrode layers.

Also, a carrier film composed of polyethylene terephthalate coated with silicone is prepared.

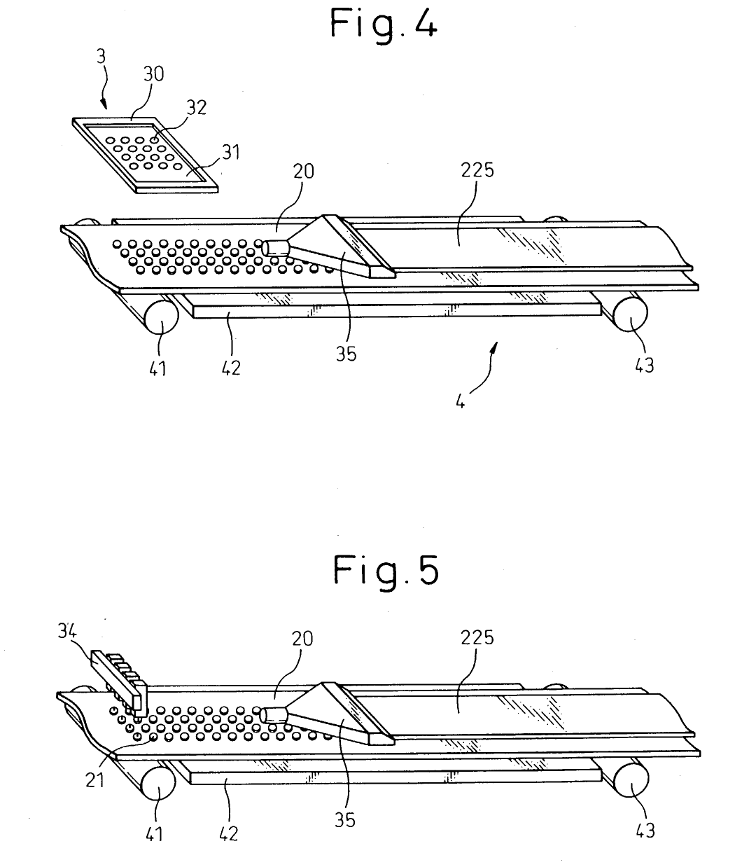

As shown in FIG. 4, the carrier film 20 is arranged on a conveyer 4 having a guide 42 interposed between two rollers 41, 43. A printing mask 3 having the slurry for the internal electrode layers mounted thereon is arranged on the carrier film 20. The printing mask 3 includes a frame 30 and a screen 31 suspended in the frame 30. The screen 31 has a plurality of print holes 32 for dropping the slurry in the shape of the internal electrode layer print portions.

The slurry is dropped on the carrier film 20 from the printing mask 3 thereby to form a multiplicity of the internal electrode layer print portions 21 in a predetermined shape.

Alternatively, as shown in FIG. 5, the carrier film 20 is arranged on the conveyor 4 having the guide 42 inserted between the two rollers 41, 43. A jet nozzle 34 adapted to eject the slurry for the internal electrode layers is arranged on the carrier film 20. Thus, the slurry for the internal electrode layers is ejected from the jet nozzle 34 to form a multiplicity of the internal electrode layer print portions 21 in a predetermined shape.

By use of one of the method shown in FIG. 4 or 5, a multiplicity of the internal electrode layer print portions 21 are formed on the carrier film 20 into the state shown in FIG. 2a. The thickness of the internal electrode layer print portions 21 is reduced by drying and contraction as shown in FIG. 2b.

Next, as shown in FIGS. 4 and 5, the slurry for the dielectric layers is applied by a coater 35 in such a way as to cover a multiplicity of the internal electrode layer print portions 21 that have been dried. In this way, a large print portion 225 is formed on the carrier film 20, as shown in FIG. 2c.

Although FIGS. 4 and 5 show a case in which the large print portion 225 is formed using the coater 35, the large print portion 225 may alternatively be formed using a doctor blade (not shown).

As the next step, the large print portion 225 is dried. As a result, as shown in FIG. 2d, a plurality of depressions 220 are formed on the surface of the large print portion 225 by drying and contraction.

After that, as shown in FIG. 2e, a coat layer 23 is formed using the coat layer slurry with the doctor blade.

The coat layer 23 is formed in such a manner as to smooth out the depressions on the surface of the large print portion 225, and therefore has a substantially flat surface with very few unevenness.

Then, as shown in FIG. 2f, the carrier film 20 is separated from the reverse surface of the large print portion 225 and the internal electrode layer print portions 21.

As shown in FIG. 6, the large print portion 225 is conveyed to a punch stacking device 5.

The punch stacking device 5, as shown in FIG. 6, includes a punching unit 51, a positioning unit 52 and a support unit 53. The punching unit 51 and the support unit 53 are arranged on the same axis. The positioning unit 52 having a window 520 is arranged between the punching unit 51 and the support unit 53. The window 520 of the positioning unit 52 has the same shape as the unsintered unit 200 formed by punching the large print portion 225 (the window 520 is somewhat larger than the unsintered unit 200 which drops on the support unit 53 through the window 520).

Specifically, the large print portion 225 is introduced into the punch stacking device 5 and arranged in position. In this state, the punching unit 51 is moved downward in the drawing, so that the unsintered unit 200 is punched by the large print unit 225. A second unsintered unit 200 is supported by the support portion 53 under the punching unit 200. The sintered unit 200 that has been punched is stacked on the second sintered unit 200 under pressure by the punching unit through the window 520 of the positioning unit 52. As a result, the sintered unit portions 200 are stacked closely, one on another, under pressure.

By repeating this process, the sintered units 200 are stacked while at the same time being punched thereby to produce an unsintered stack body 2 having a predetermined number of layers.

The print portion for the dummy layer 29 similar to the large print portion 225 is arranged as a component part making up the uppermost and the lowest layers of the unsintered stack body 2.

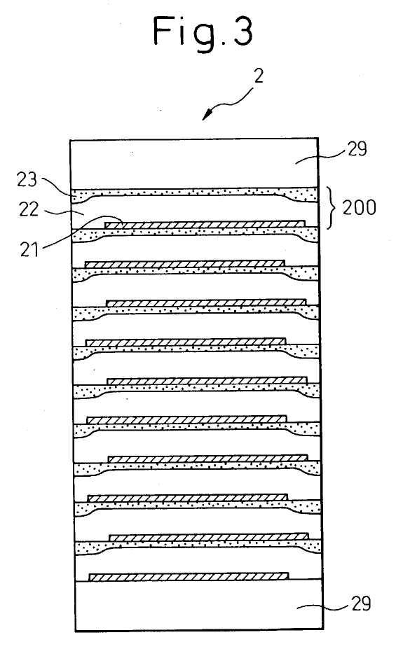

The unsintered stack body 2 thus produced does not develop gap between layers, as shown in FIG. 3. The unsintered stack body 2 is sintered for two hours at 1000° C. thereby to produce a ceramic stack structure 1. Then, the side electrodes 14, the lead portions 141, etc. are mounted.

The operation and the effects of this embodiment will be explained.

Once the large print portion 225 is dried, a plurality of depressions 220 develop on the surface thereof due to contraction. A coat layer 23 is formed in such a manner as to smooth out the depressions 220.

The unsintered unit 200 produced from the large print portion 225 having the coat layer 23, therefore, has a flat surface, and the unsintered stack body 2 having a plurality of the unsintered units 200 in stack develops no gap between the dielectric layer print portions 22. By sintering the unsintered stack body 2, therefore, it is possible to produce a superior ceramic stack structure 1 neither cracked nor delaminated.

Also, in the fabrication method according to this embodiment in which the punching step and the stacking step are carried out simultaneously, the unevenness such as small depressions left on the coat layer 23 after punching and stacking is corrected by being smoothed out under the stacking pressure. Therefore, the gaps, etc. developed in the unsintered stack body 2 are further reduced in size.

Further, the fact that the stacking step is carried out at the same time as the punching step makes it possible to shorten the fabrication time more than in the case where the punching step and the stacking step are carried out separately from each other. Also, the step of attaching the unsintered units 200 to each other under pressure is eliminated, thereby contributing to an improved efficiency of the fabrication process.

As described above, according to this embodiment, there is provided a method of fabricating the ceramic stack structure 1 in which the dielectric layers 12 are not easily cracked or delaminated.

With the fabrication method according to this embodiment, the punching step is conducted downward. Alternatively, the punching step can be conducted upward, so that the punched unsintered units may be stacked and attached to each other under pressure using a jig such as a holder arranged above the large print portion 225.

What is claimed is:

1. A method of fabricating a ceramic stack structure configured of a plurality of dielectric layers and a plurality of internal electrode layers stacked alternately with each other, the method comprising the steps of:
preparing a carrier film;
forming a plurality of internal electrode layer print portions on said carrier film;
forming a dielectric layer print portion in such a manner as to cover said internal electrode layer print portions;
drying said dielectric layer print portion;
forming a coat layer in such a manner as to smooth out the unevenness of the surface of said dielectric layer print portion thereby to produce an unsintered unit including said internal electrode layer print portions, said dielectric layer print portion and said coat layer;
removing said unsintered unit from said carrier film;
stacking a plurality of said unsintered units into an unsintered stack body; and
sintering said unsintered stack body into a ceramic stack structure.

2. A method of fabricating a ceramic stack structure according to claim 1, wherein said dielectric layer is composed of a piezoelectric material.

3. A method of fabricating a ceramic stack structure configured of a plurality of dielectric layers and a plurality of internal electrode layers stacked alternately with each other, the method comprising the steps of:
preparing a carrier film;
forming a plurality of internal electrode layer print portions on said carrier film;
forming a large print portion in such a manner as to cover a plurality of said internal electrode layer print portions;
drying said large print portion;
forming a coat layer in such a manner as to smooth out the unevenness of the surface of said large print portion;
removing said large print portion with said internal electrode layer print portions and said coat layer from said carrier film;
punching said large print portion thereby to produce an unsintered unit including said internal electrode layer print portion, a dielectric print portion and said coat layer;
punching said unsintered unit while at the same time attaching said unsintered unit on another unsintered unit under pressure, the step being repeated thereby to form an unsintered stack body including a plurality of the unsintered units; and
sintering the unsintered stack body into a ceramic stack structure.

4. A method of fabricating a ceramic stack structure according to claim 3, wherein said dielectric layers are composed of a piezoelectric material.
